(19) United States
(12) Patent Application Publication
(10) Pub. No.: US 2001/0044027 A1
(43) Pub. Date: Nov. 22, 2001

(54) Diamond-like carbon coating on glass for added hardness and abrasion resistance

(76) Inventor: Jerrel Charles Anderson, Vienna, WV (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/747,673

(22) Filed: Dec. 22, 2000

Related U.S. Application Data
(60) Provisional application No. 60/174,052, filed on Dec. 30, 1999.

(51) Int. Cl. B32B 9/00

(52) U.S. Cl. 428/408; 428/336

(57) ABSTRACT

The present invention is a non-metallic article that has been coated with a diamond-like carbon (DLC) coating. A coated article of the present invention has increased hardness, increased abrasion resistance, and a reduced coefficient of friction when compared with the same properties of the article prior to the article being coated. DLC coatings of the present invention are applied in a chamber filled with hydrocarbon plasma and with application of electrical pulses.

### BACKGROUND OF THE INVENTION

1. Field of the Invention

This invention relates to hard surfaced articles that are coated for increased hardness and abrasion resistance. This invention particularly relates to coatings that increase hardness and abrasion resistance on initially hard surfaced materials such as glass and ceramics.

2. Description of the Prior Art

Protective coatings on surfaces that come in contact with other objects can be desirable in applications where the surface can be scratched or abraded by such contact, and where such wear on the surface is undesirable. In addition, hard protective coatings that also have a low coefficient of friction can be desirable in applications where good wear resistance is necessary or desirable. Applying DLC coatings to hard metallic surfaces has been carried out using the plasma source ion implantation (PSII) technique, wherein a potential is applied to an article that is to be coated in order to attract the plasma ions to the surface of the article. U.S. Pat. No. 4,764,394 describes the PSII technique, and how it can be useful for implanting ions beneath the surface of various materials. The PSII method utilizes high voltage of typically greater than 20 kilovolts to drive plasma ions beneath the surface of a target material.

It can be desirable to apply a hard coating to an object in order to increase surface hardness, increase abrasion resistance, and/or to lower the coefficient of friction on the surface of the article.

### SUMMARY OF THE INVENTION

In one aspect, the present invention is an article comprising a diamond-like carbon (DLC) coating on a non-metallic hard surface.

In one aspect, the present invention is an article comprising a diamond-like carbon (DLC) coating on a non-metallic hard surface, wherein the non-metallic surface is glass.

In another aspect, the present invention is an article comprising a DLC coating on a non-metallic hard surface, wherein the non-metallic surface is coated in a process comprising the step of applying a high-voltage electrical pulse to the surface while the surface is immersed in a hydrocarbon plasma.

In another aspect, the present invention is an article comprising a DLC coating on a non-metallic hard surface, wherein the non-metallic surface is coated in a process comprising the step of applying a high-voltage electrical pulse to the surface while the surface is immersed in a hydrocarbon plasma, and wherein the non-metallic surface is glass.

In still another aspect, the present invention is a process of making a DLC coated non-metallic article, the process comprising the steps of: placing a substrate article on a metallic holder in such a manner that a portion of the surface of the substrate can be exposed to a plasma; immersing the article in a plasma; and applying an electric current to the metallic holder such that the plasma particles are deposited onto the exposed surface of the substrate.

### DETAILED DESCRIPTION

In one embodiment, the present invention is a non-metallic article having a hard surface, which has been coated with a diamond-like carbon covering. Articles coated in the practice of the present invention are non-metallic articles having a hard surface such as glass, ceramics, or laminated articles. A DLC coated article of the present invention has increased hardness, increased abrasion or scratch resistance, and a lower coefficient of friction on the surface of the coated article than the non-coated article.

A DLC coated article of the present invention can be obtained by applying a high-voltage potential to an article while the article is immersed in plasma. The plasma can consist of any hydrocarbon gas or mixture of gasses, such as, for example, methane, ethane, any or all isomers of propane, any or all isomers of butane, ethene, any or all isomers of propene, acetylene, propyne, 1-butyne, 2-butyne, similar compounds, and mixtures of any of these. Preferably the plasma includes acetylene.

In the practice of the present invention, a high-voltage potential can be applied to an article immersed in plasma for periods of shorter or longer duration, depending on the thickness of the DLC coating desired. Thicker DLC coatings require longer periods of exposure to plasma, while thinner DLC coatings do not require as long a period of exposure as a potential is applied. Coatings of from about 0.001 to about 5 microns are obtained in the practice of the present invention. Preferably coatings of from about 0.005 to about 4.5 microns are obtained. More preferably coatings of from about 0.010 to about 4.0 microns, and most preferably coatings of from about 0.100 to about 3.5 microns are obtained.

High voltage, as used herein, means a potential of at least about 0.5 kilovolt (kV), preferably at least about 1.0 kV, more preferably at least about 1.5 kV, and most preferably at least about 2 kV. In the practice of the present invention, a high voltage potential can be applied to a second article that is in contact with the article to be coated. Preferably, the second article is conductive and is in contact with at least about 30% of the surface area of the article. Preferably, 100% of the surface to be coated is exposed to the plasma.

A DLC coated article of the present invention can be obtained by a process comprising the steps: cleaning the surface of the article to be coated; placing the article in contact with a conductive material; placing the article in a PSII (plasma source ion implantation) chamber; removing air and moisture from the samples by evacuating the chamber; further cleaning the surfaces by sputtering the surface with an inert gas, e.g. argon, plasma; introducing a hydrocarbon vapor to the chamber; and applying an electrical pulse of voltage in the range of less than about 10 kV, preferably less than about 5 kV, more preferably less than about 4 kV, and most preferably less than about 3 kV to the chamber and its contents, to obtain a DLC coated article.

An electrical pulse can be applied to the target object to be coated for a sufficient time to obtain coatings of various thicknesses. The pulse can be be applied multiple times in order to obtain the desired coating. For example, coating thicknesses in the range of from about 0.01 to about 5 microns can be obtained by subjecting the article the plasma for up to about 24 hours.

The hardness of an article coated with a DLC coating is increased compared to the hardness of the non-coated article. The penetration depth of an impinging load is decreased for a coated article compared to that of a non-coated article. The coefficient of friction of a DLC coated article of the present invention is decreased compared to that of the non-coated article.

DLC coated articles of the present invention can have good optical properties, such as low haze and high clarity. The optical properties can be dependent on the thickness of the DLC coating on the article. Haze values of DLC coated articles of the present invention can be less than 3.0%, preferably less than 2.5%, more preferably less than 1%, and most preferably less than 0.5%. Clarity of a DLC coated article of the present invention can be greater than 92%, preferably greater than 95%, more preferably greater than 97%, and most preferably greater than 98%.

DLC coated articles of the present invention can be useful as, for example, architectural glazing, sidelights on automobiles, automobile rock shields, guide pins, etc.

### EXAMPLES

The following examples are presented to illustrate the invention described herein, but in no way are meant to limit the scope of the present invention.

### Example 1

Two float glass 4×4×0.090 inch panels are thoroughly cleaned, then placed in a horizontal position with one panel having the tin side up (exposed to the atmosphere) and the other panel having the non-tin side up. The panels are laid on a water-cooled horizontally placed aluminum plate in a PSII chamber. The aluminum plate is electrically connected to the generator of the pulsed potential power source. The chamber is evacuated via a vacuum pump for an hour to remove air and excess moisture from the samples. After an hour, the samples are sputtered using an plasma created with 10 milli-torr of argon for 10 minutes to clean the surfaces. Acetylene is introduced at a pressure of 5 milli-torr and the plasma is started and run for 4 hours to obtain a uniformly coated DLC coated article. The DLC coating is 1.36 microns in thickness, as determined by use of both a RUDOLPH FTM film thickness measuring instrument and a profilometer. The coating was tested using the pencil hardness test (ASTM D3363-74, reapproved in 1989), and was not scratched by even the hardest lead (6H). The Taber abrasion test is also run (ANSI Z-26.1 Standard No.34), and the DLC has 0% haze increase thereby showing very superior resistance to abrasion.

Two additional tests were run with the PSII apparatus wherein glass samples were subjected to the acetylene plasma for 9 and 17 hours to give DLC coatings measuring 1.8 and 3.2 microns thick, respectively. These samples were evaluated for hardness, Young's Modulus, coefficient of friction, and penetration depth at 20 mN. The results are given in Table 1 below.

TABLE 1

| | HARD- | | COEF- | PENETRATION |
|---|---|---|---|---|
| | NESS | YOUNG'S | FICIENT OF | DEPTH |
| SAMPLE | (Gpa) | MOD (Gpa) | FRICTION | AT 20 mN |
| Glass | 8 | 72 | 0.71 | 1,100 nm |
| DLC @ | 15 | 105 | 0.35 | 500 nm |
| 1.8 | | | | |
| microns | | | | |
| DLC @ | 15 | 115 | 0.33 | 450 nm |
| 3.2 | | | | |
| microns | | | | |

Three additional samples of 90 mil glass were coated according to the above procedures, and the Haze was measured according to the ASTM D 1003 method using a model “Haze-gard Plus” Gardner Haze Meter. The same instrument was also used to measure the clarity of each sample. Clarity is a measure of see-through quality and describes how well very fine detail is resolved through the specimen. The results are shown in Table 2.

TABLE 2

| | DLC Coating | | |
|---|---|---|---|
| Sample | Thickness (microns) | Haze (%) | Clarity (%) |
| Control | 0 | 0.2 | 100 |
| DLC1 | 0.2 | 0.2 | 99.8 |
| DLC2 | 1.36 | 0.7 | 98.7 |
| DLC3 | 1.8 | 2.3 | 98.5 |

The DLC coating adds very little haze and has a minimal affect of clarity, thereby showing it to be a viable coating for optically sensitive applications such as glazing.

1. An article comprising a diamond-like carbon (DLC) coating on a non-metallic material, wherein the DLC coating is from 0.001 to about 5 microns thick.

2. The article of claim 1 wherein the non-metallic surface is coated in a process comprising the step: applying a high-voltage electrical pulse to the surface while the surface is immersed in a chamber filled with a hydrocarbon plasma.

3. The article of claim 2 wherein the non-metallic material is glass.

4. The article of claim 3 wherein the DLC coating is from about 0.005 microns to about 4.5 microns thick.

5. The article of claim 4 wherein the DLC coating is from about 0.010 microns to about 4.0 microns thick.

6. The article of claim 5 wherein the DLC coating is from about 0.050 microns to about 3.5 microns thick.

7. The article of claim 6 wherein the voltage of the electrical pulse is from about 0.5 to about 10 kV.

8. The article of claim 7 wherein the voltage of the electrical pulse is from about 1.0 to about 5 kV.

9. The article of claim 8 wherein the voltage of the electrical pulse is from about 1.5 to about 4 kV.

10. The article of claim 9 wherein the voltage of the electrical pulse is from about 2 to about 3 kV.
